(19) United States
(12) Patent Application Publication
(10) Pub. No.: US 2008/0221744 A1
(43) Pub. Date: Sep. 11, 2008

(54) Process And Apparatus For Autonomous Control Of A Motor Vehicle

(76) Inventors: Dennis W. Doane, Cincinnati, OH (US); John B. William, St. Leon, IN (US)

Correspondence Address: WM. CATES RAMBO;508 MERCANTILE LIBRARY BLDG., 414 WALNUT STREET, CINCINNATI, OH, 45202-3913, US

(21) Appl. No.: 11/846,104

(22) Filed: Aug. 28, 2007

Related U.S. Application Data
(60) Provisional application No. 60/840,641, filed on Aug. 28, 2006.

(51) Int. Cl. G05D 1/00

(52) U.S. Cl. 701/2

(57) ABSTRACT

Autonomous control of steering, speed, forward and reverse movement of a motor vehicle is provided by transmitting a signal from a transmitter carried by an ambulatory user, receiving the signal with three signal-receiving antennae on the motor vehicle, generating first, second and third sub-signals with a three-channel receiver connected to the three antennae, generating sum and difference outputs with the first and second sub-signals, affecting the steering with the difference output, affecting the speed, forward and reverse control with the sum output, generating a distance-to-user output from the third sub-signal, and limiting the proximity of the motor vehicle to the user with the distance-to-user output.

### CROSS TO REFERENCE TO RELATED APPLICATION

The present U.S. Non-Provisional Patent Application is related to U.S. Provisional Application for Patent No. 60/840,641 filed Aug. 28, 2006 and entitled “Autonomous Golf Equipment Transportation System”, and is incorporated herein by reference in its entirety.

### BACKGROUND OF THE INVENTION

1. Field of the Invention

The present invention relates to a method and apparatus for autonomous control of a motor vehicle, and more specifically to a method and apparatus by which the vehicle follows an ambulatory user at a selected distance.

2. Related Art

The weight and structure of a typical golf club bag can be quite cumbersome when carried or pulled over the terrain of a golf course. While many golfers have the desire to walk, carrying a golf bag can be too strenuous. Additionally, it often prohibits a player from maintaining the required speed of play. As a result, the ability to maintain the optimal concentration and focus associated with walking the course must be sacrificed to some degree. For years, manufacturers of golfing equipment transportation devices have sought to overcome this “handicap”. The electronic remote control golf caddy has steadily increased in availability since its introduction and currently appears to dominate the field of possible solutions. Of the many known variations however, none is without limitation to the realization of true freedom for a golfer to devote all of his or her energy to the game rather than the equipment. Relevant prior art includes: U.S. Pat. No. 3,720,281 to Frownfelter; U.S. Pat. No. 3,742,507 to Pirre; U.S. Pat. No. 3,812,929 to Farque; U.S. Pat. No. 3,976,151 to Farque; U.S. Pat. No. 4,023,178 to Suyama; U.S. Pat. No. 4,109,186 to Farque; U.S. Pat. No. 4,844,493 to Kramer; U.S. Pat. No. 5,350,982 to Seib; U.S. Pat. No. 5,517,098 Dong; U.S. Pat. No. 5,711,388 to Davies et al.; U.S. Pat. No. 6,142,251 to Bail; U.S. Pat. No. 6,327,219 to Zhang et al.; U.S. Pat. No. 6,404,159 to Cavallini; and U.S. Pat. No. 6,834,220 to Bail. Other relevant publications are: Powakaddy International Limited, www.powakaddy.com, © 2006; KaddyKarts, Inc., www.kaddykarts.com, © 2006; High Degree Machinery and Electronic Co., Ltd., www.golftrolley.cn, ©2006; SpaCom International LLC, www.batcaddy.com, © 2006; and CaddyBug usa, www.caddybug-usa.com, ©2005

### SUMMARY OF THE INVENTION

In an exemplary form, the present process and apparatus for autonomous control of a motor vehicle comprises: a) transmitting a signal from a device carried by an ambulatory user;

b) receiving said signal with three signal-receiving antennae on the motor vehicle; c) generating first, second and third sub-signals with a three-channel receiver connected to said three antennae;
d) generating sum and difference outputs with the first and second sub-signals; e) affecting the steering with said difference output; f) affecting the speed, forward and reverse control with the sum output;
g) generating a distance-to-user output from the third sub-signal; and h) limiting the proximity of the motor vehicle to the user with the distance-to-user output.

### BRIEF DESCRIPTION OF THE DRAWINGS

FIG. 1 is a block diagram of an exemplary embodiment of the present method and apparatus;

FIG. 2 is a process flow chart of the embodiment of FIG. 1;

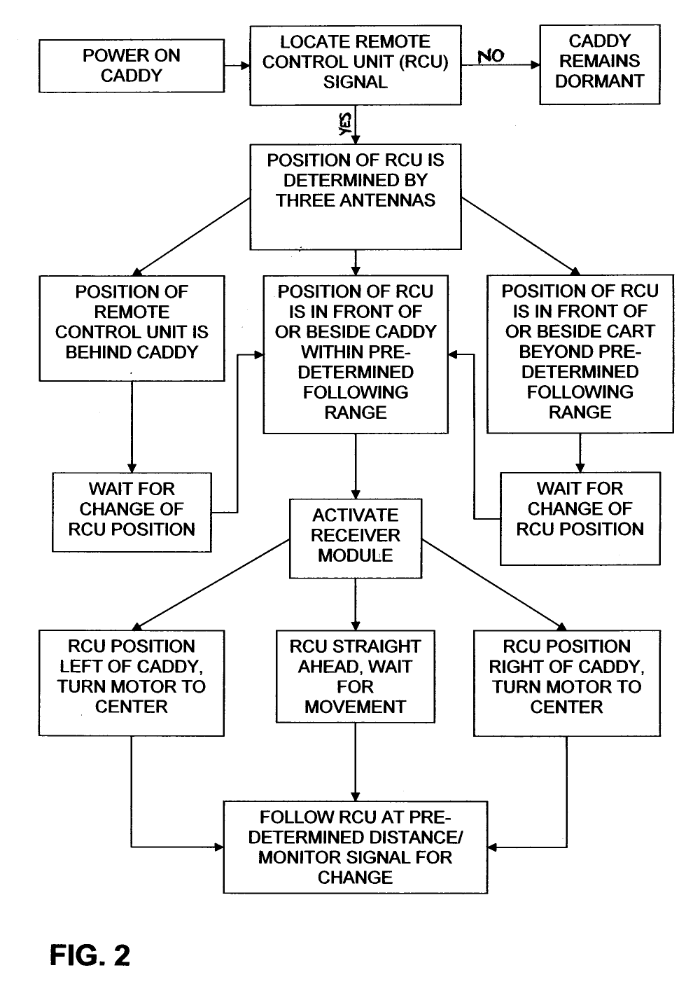

FIG. 3 is a schematic front view of a transmitter according to the exemplary embodiment; and

FIG. 4 is a schematic top view of the transmitter of FIG. 3.

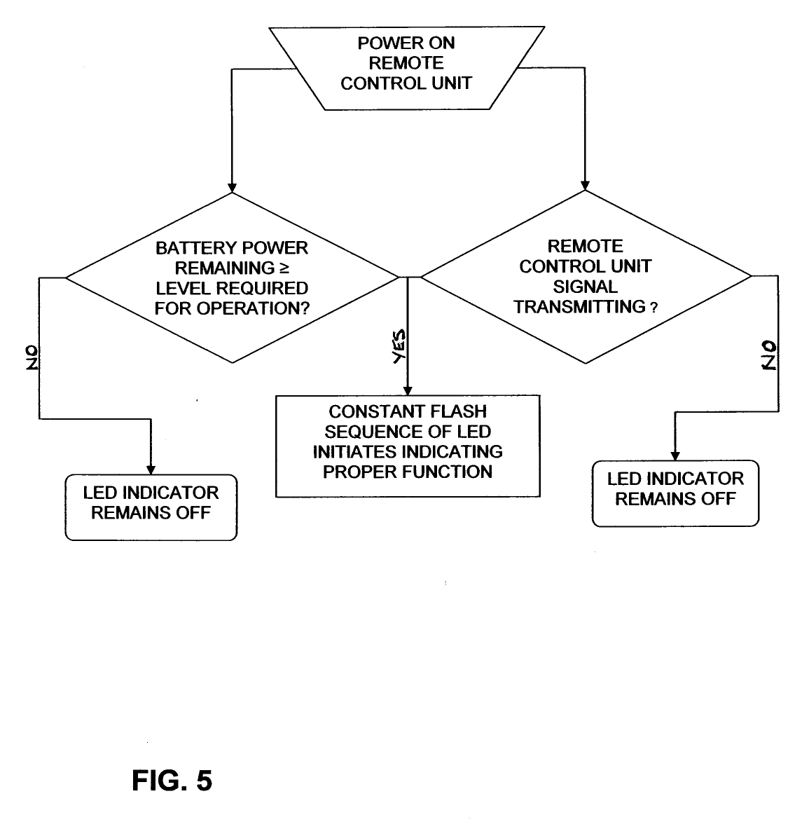

### DETAILED DESCRIPTION OF AN EXEMPLARY EMBODIMENT OF THE INVENTION

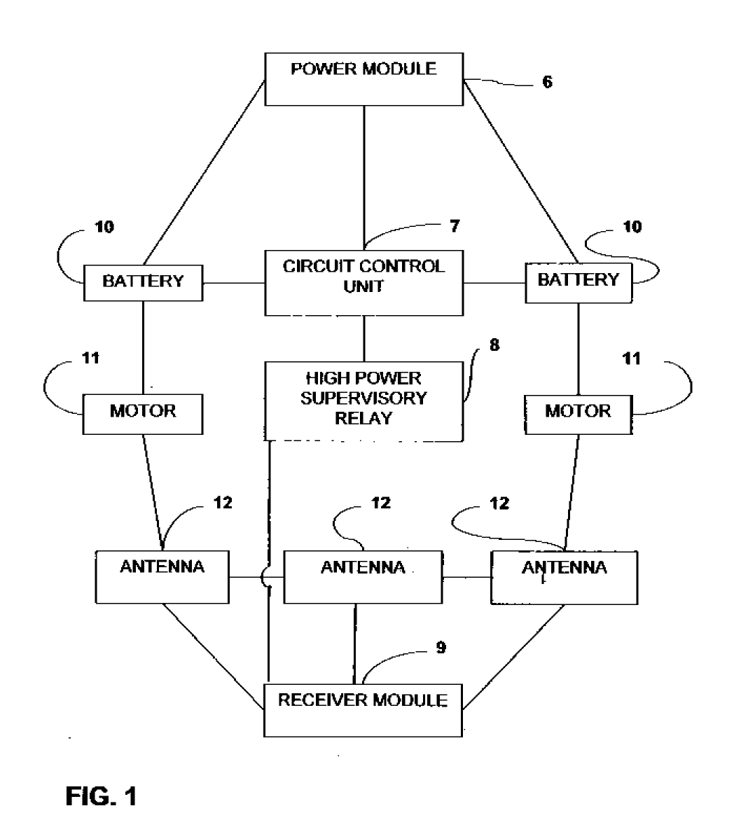

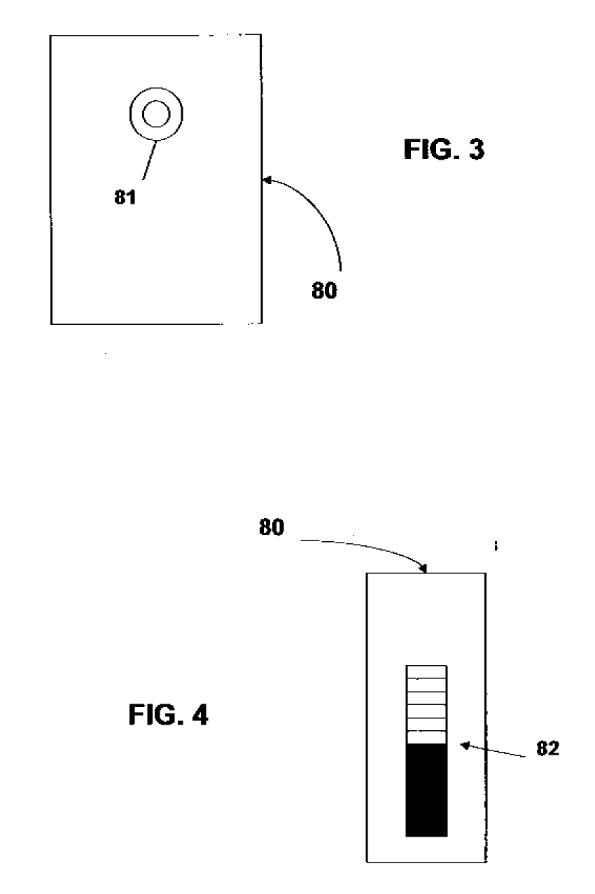

As illustrated in FIGS. 1 and 3, the apparatus for autonomous control of a motor vehicle may comprise a power module 6, a high power supervisory relay 7, a circuit control unit 8, a receiver module 9, two batteries 10, two motors 11, three antennas 12, a transmitter 80 carried by an ambulatory user, and an LED indicator 81 and an on/off toggle switch 82 on the transmitter 80. The present motor vehicle may be a self-propelled golf equipment cart.

Exemplary features of the foregoing components are as follows. The user-carried transmitter 80 illustrated in FIG. 3 is an intentional radiator of low power, low frequency, continuous wave radio frequency energy. The emitted signal is in the long wavelength spectrum, located below the AM radio broadcast band and designated for directional radio systems. Four different channel frequencies may be available to allow multiple carts to be used in the same group of golfers. For example, channel 1 may be 230 kHz, channel 2 may be 300 kHz and so on.

The transmitter 80 may be powered by a common 9V transistor radio battery. A flashing LED indicator 81 may be provided to indicate the transmission status of the unit 80. In addition, the indicator 81 may change color to indicate battery condition, such as green to indicate a charged battery, yellow to indicate that battery replacement or recharging is needed, and red to indicate that the electrical charge is too low for the remote control unit 80 to function correctly. The output of the transmitter 80 is regulated to remain constant as the battery is discharged; otherwise, the cart would follow the user at a shorter distance as the battery voltage drops. When the battery voltage drops below the point where the proper output can be sustained, the transmitter 80 is tuned off automatically, and the indicator 81 will flash red to prevent anomalous operation due to a weak battery.

The antennae 12 (FIG. 1) may be loop stick ferrite core coils tuned to the desired channel frequency with a low impedance secondary winding output. Preferably, three antennae 12 are used, one located on the left front, one on the right front, and one on the rear center of the equipment cart. Shielded coaxial cables could connect the antennae 12 to the receiver module 9.

The receiver module 9 may consist of three radio receiver channel inputs each tuned to the desired channel frequency. These inputs are connected to the three antennae 12 (left, right, and rear) described in the previous paragraph. The Left and Right channels have an input buffer amplifier stage connected to a sum and difference amplifier circuit. This circuit has two outputs, one is a sum of the left and right signals and the other is the difference between the amplitudes of the left and right signals.

The difference in signal strength from the transmitter 80 dictates the cart's steering. The output of this switching circuit develops a DC signal with polarity and amplitude proportional to the difference in amplitude between left and right signals and is used to control Left/Right steering of the cart. If the user-carried transmitter 80 is positioned in front of the cart, in range, and toward the left, the difference of the signal strength received by each side, right and left, dictates how far to the left the cart will turn from center. A difference amplifier circuit is used to make this calculation.

The sum amplifier circuit calculates the signal strength received from the transmitter 80 to determine how much to speed up or slow down the forward or backward motion of the cart. The sum output is connected to additional stages of amplification and develops an automatic gain control signal, which is used by both the left and right amplifiers to regulate gain. The automatic gain control signal is proportional to the distance of the user to the antennae and is also used to regulate speed and forward or reverse movement of the cart. The sum output is also used to synchronize a switching circuit, which samples the difference signal at the carrier rate. The carrier rate refers to the different frequency used by each channel, since, as previously indicated, different channels may be assigned to various carts to allow more than one cart to be used at the same time on each golf hole.

The automatic gain control/speed signal and the Left/Right steering signal may be added together to produce a speed/direction signal for the two cart motors 11. The cart steers by controlling the direction and speed of each motor 11 separately. This signal may be referenced to 2.5 VDC, which is zero speed or stopped. If the voltage is above 2.5V, the motor will drive in one direction; if the voltage is below 2.5V, the motor will drive in the opposite direction at a speed proportional to the difference between +2.5V and the signal. For example, +5 VDC could be full speed in one direction, and 0 VDC could be full speed in the opposite direction. If the automatic gain control/speed signal is calling for backward movement, a DC signal to operate a backup beeper may be activated.

The third channel antenna 12 and receiver 9 channel may be used to prevent the cart from turning on when the user is positioned behind the cart. The turn-on may be controlled by monitoring the left and right motor speed signals so that the cart turns on when the user is located approximately 5 feet from both the left and right antennas. This could be the normal distance that the cart follows the user, and the motors are practically stopped. However, this condition is satisfied at two possible locations, one when the user is in front of the cart, and the other when the user is in back. If the cart were turned on with the user in back of the cart, it would spin 180 degrees fairly rapidly. This would occur when the motors start to move after turn on, as they will move in the opposite direction if the user is behind the cart. If this were allowed to occur, it could cause injury to someone in the vicinity of the cart. To prevent this, the third antenna 12 is mounted at the rear of the cart, and its associated amplifier develops a signal proportional to the distance to the user. If this signal is above a certain amplitude, indicating that the user or another user is too close to the rear of the cart, the cart will not turn on, or if already on will shutoff. This is an important safety feature preventing the cart spin-around problem just described or allowing another user interfering with the proper directional control of the cart. When all three antenna signals are at the appropriate amplitude indicating the user is directly in front of the cart at the prescribed distance, the receiver module 9 will send a signal activating the power module 6. The motors 11 will power up and the brakes will be released with only a small amount (if any) of cart movement. The cart will not turn on if the user is either too close or too far from the cart which would result in a rapid movement to catch up. A red LED lamp on the receiver module indicates the power module is activated and the cart ready to move. This signal is latched and remains on unless the signal from the user is lost or goes out of range limits for any reason. If the cart is prevented from keeping up with user movement, (such as slipping wheels) it will shut off when the user gets too far away from cart and the automatic gain control/speed signal goes beyond a preset limit.

The power module 6 controls motor speed and direction in response to the two speed/direction signals from the receiver module 9. A motor ON signal from the receiver module 9 turns on the high power supervisory relays 7 that connect the batteries to the FET transistors that rapidly switch the DC power to the motors 11 to control the speed of the motors. This motor ON signal also applies power to the brake circuit releasing the motor brakes. If the receiver module 9 turns off the motor ON signal, (e.g., the User switches the transmitter off or there is loss of signal for any reason) the batteries are disconnected from the motor drive circuit and brakes are applied immediately.

The motor's speed and direction is controlled by comparing the speed/direction signal from the receiver module 9 with an internally generated voltage ramp signal resulting in a digital output pulse whose duration is proportional to the absolute difference between the speed signal and the 2.5V reference level. This pulse is applied to the gates of the appropriate (forward or backward bank of three) power FET transistors to apply full battery power to the motor 11 for the duration of the pulse. The more speed that is called for results in a longer time that power is switched on the motor 11. At full speed, the pulse width approaches the pulse repetition time so that power is on continuously, resulting in full motor speed. Conversely, as the control calls for less speed, the power is applied for a shorter time interval until the pulse width is practically zero, causing the motor to stop.

If the motor is coasting, it acts as a voltage generator. This motor-generated voltage is applied as negative feedback to the control circuit 8, so that the control circuit 8 can apply reverse polarity to dynamically brake the motors. This arrangement is needed when the cart is going down a hill or stopping on a hill to prevent it from running into the user or coasting backward. The power module also has a DC to DC switching power supply to generate a higher ‘boost’ voltage (approx 36 VDC) to allow full turn-on of the FET transistor connected to the +12V battery. A protection circuit shuts off the supervisory relays 7 if this circuit fails, thereby preventing burn-up of the power FET transistors due to insufficient gate drive.

Finally, each of the power FET transistors (12 in all) has a fusible link of #30 AWG wire that will open the circuit in the event of a power FET transistor shorting out. This is to prevent circuit board burn-up in the event of a component failure.

1. A process for autonomous control of steering, speed, forward and reverse movement of a motor vehicle comprising the steps of:
a. transmitting a signal from a device carried by an ambulatory user;
b. receiving said signal with three signal-receiving antennae on the motor vehicle;
c. generating first, second and third sub-signals with a three-channel receiver connected to said three antennae;
d. generating sum and difference outputs with the first and second sub-signals;
e. affecting the steering with said difference output;
f. affecting the speed, forward and reverse control with the sum output;
g. generating a distance-to-user output from the third sub-signal; and
h. limiting the proximity of the motor vehicle to the user with the distance-to-user output.

2. The process according to claim 1 wherein the step of affecting the steering with the difference output comprises developing a steering signal with polarity and amplitude proportional to the difference in amplitude between the first and second subsignals

3. The process according to claim 2 wherein the step of affecting the speed, forward and reverse movement with the sum output comprises generating an automatic gain control signal from the sum output.

4. The process according to claim 3, and further comprising the step of providing a combined automatic gain control and steering signal

5. The process according to claim 4, and further comprising the step of providing the motor vehicle with two motors.

6. The process according to claim 5, and further comprising the steps of referencing the combined automatic gain control and steering signal to a reference voltage and producing separate drive/steering signals for each of the two motors.

7. The process according to claim 6, wherein the drive/steering signal runs the motor to which said signal is applied at a speed proportional to the difference between the reference voltage and the drive/steering signal.

8. The process according to claim 7, wherein the drive/steering signal runs the motor to which said drive/steering signal is applied in a direction determined by whether the reference voltage is greater or less than said drive/steering signal.

9. The process according to claim 8, and further comprising producing an electrical pulse proportional in duration to the absolute difference between the drive/steering signal and the reference voltage.

10. The process according to claim 9, and further comprising applying the electrical pulse to the gates of selected power FET transistors to apply full battery power to the motor for the duration of the pulse.

11. Apparatus for autonomous control of steering, speed, forward and reverse movement of a motor vehicle comprising:
a. a signal-generating transmitter adapted to be carried by an ambulatory user;
b. three signal-receiving antennae located in a triangular pattern on the motor vehicle;
c. a three-channel receiver connected to said three antennae, said receiver generating first, second and third sub-signals;
d. sum and difference amplifier circuits receiving the first and second sub-signals and generating sum and difference outputs;
e. means for affecting the steering with said difference output;
f. means for affecting the speed, forward and reverse movement with the sum output
g. means for generating a distance-to-user output from the third sub-signal; and
h. means for limiting the proximity of the motor vehicle to the user with the distance-to-user output.

12. The apparatus according to claim 11, wherein the distance-to-user output from the third sub-signal is proportional in amplitude to the distance between the third antenna and the user.

13. The apparatus according to claim 12, and further comprising means for generating a motor activation signal if the distance-to-user signal is below a selected amplitude.

14. The apparatus according to claim 13, and further comprising a brake on the motor vehicle, said brake being releasable in response to the motor activation signal.

15. The apparatus according to claim 14, and further comprising means for applying the brake when the motor vehicle is going down a hill.
